(19) United States
(12) Patent Application Publication
(10) Pub. No.: US 2011/0105008 A1
(43) Pub. Date: May 5, 2011

(54) CATALYTIC AIR PURIFICATION SYSTEM FOR A VEHICLE USING MULTIPLE HEAT SOURCES FROM AN ENGINE

(75) Inventors: BIJAN F. HAGH, Newport Beach, CA (US); E. SCOTT WRIGHT, Tempe, AZ (US); ADEL ELSAYED, Yorba Linda, CA (US); RUSSELL W. JOHNSON, Elmhurst, IL (US)

(73) Assignee: HONEYWELL INTERNATIONAL INC., MORRISTOWN, NJ (US)

(21) Appl. No.: 12/609,532

(22) Filed: Oct. 30, 2009

(51) Int. Cl. B60H 1/03; B01D 53/94

(52) U.S. Cl. 454/159; 422/177

(57) ABSTRACT

An air purification system for a vehicle may comprise a first heated-ambient-air source comprising an engine with an ambient air compressor; and at least one heated-ambient-air outlet. The system may also comprise a second heated-ambient-air source; a mixing valve; a first heated-ambient-air channel connected between the at least one heated-ambient-air outlet of the engine and the mixing valve; a second heated-ambient-air channel connected between the second heated-ambient-air source and the mixing valve; and a catalytic decontamination unit positioned between the mixing valve and an enclosed passenger cabin of the vehicle for removing contaminants from ambient air and producing decontaminated air to the enclosed passenger cabin.

### BACKGROUND OF THE INVENTION

The present invention generally relates to air purification and more particularly to catalytic purification of breathable air for an enclosed passenger cabin of a vehicle.

Some vehicles with human occupants may be required to operate in environments in which ambient air is contaminated. Typically such vehicles provide isolated enclosures for the occupants. Specialized air supply systems for such enclosures may provide de-contaminated, non-harmful breathable air for the occupants.

Such vehicles are often employed in military applications. For these applications, vehicle design standards may define requirements for de-contamination of ambient air which may contain nuclear, biological and/or chemical contaminants, so-called NBC contaminants. Examples of vehicles that may need NBC protection may include tanks, armored personnel carriers, low-altitude aircraft or enclosed patrol vehicles.

NBC decontamination in these vehicles may be performed by heating ambient air and passing the heated air through an on-board catalytic purification system. Dedicated heater units are typically provided within a vehicle to heat incoming ambient air to a temperature high enough to accommodate catalytic decontamination reaction. Dedicated heater units consume fuel and add weight and cost to a vehicle.

As can be seen, there is a need for a vehicular ambient-air decontamination which may operate without use of a dedicated heating unit or with reduced use of a heating unit.

### SUMMARY OF THE INVENTION

In one aspect of the present invention, an air purification system for a vehicle may comprise a first heated-ambient-air source comprising an engine with an ambient air compressor and at least one heated-ambient-air outlet; a second heated-ambient-air source; a mixing valve; a first heated-ambient-air channel connected between the at least one heated-ambient-air outlet of the engine and the mixing valve; a second heated-ambient-air channel connected between the second heated-ambient-air source and the mixing valve; and a catalytic decontamination unit positioned between the mixing valve and an enclosed passenger cabin of the vehicle for removing contaminants from ambient air and producing decontaminated air to the enclosed passenger cabin.

In another aspect of the present invention, a vehicle may comprise: an enclosed passenger compartment isolated from ambient air; at least one inlet for ambient air; at least first and second sources of heat for heating the ambient air. At least a first one of the at least two sources of heat may comprise an engine with an ambient air compressor and at least a first heated-ambient-air outlet. The vehicle may also comprise a temperature-controlled mixing valve; a first heated-ambient-air channel connected between the at least one heated-ambient-air outlet of the engine and the mixing valve; a second heated-ambient-air channel connected between a second heated-ambient-air source and the mixing valve; a catalytic decontamination unit positioned between the mixing valve and an enclosed passenger cabin of the vehicle for removing contaminants from ambient air and producing decontaminated air to the enclosed passenger cabin. The first source of heat may produce heated ambient air suitable for the catalytic decontamination unit only when the vehicle operates under engine-loaded conditions; and the second source of heat may produce heated ambient air suitable for the catalytic decontamination unit when the vehicle is in an idling condition.

In still another aspect of the invention, a method for providing decontaminated air to an enclosed passenger cabin of a vehicle operated in contaminated ambient air may comprise the steps of: admitting ambient air into the vehicle; heating a first portion of the admitted ambient air with a first ambient-air heater comprising a compressor of an engine of the vehicle to produce a first portion of heated ambient air: delivering the first portion of heated ambient air to a mixing valve: heating the a second portion of the ambient-air with a second ambient-air heater to produce a second portion of heated ambient air; delivering the second portion of heated ambient air to the mixing valve: mixing the first and second portions of heated ambient air in the mixing valve to produce controlled-temperature heated ambient air at a temperature within an operating range of a catalytic decontamination unit of the vehicle; catalytically decontaminating the controlled-temperature heated ambient air to produce purified air; and introducing the purified air into the enclosed passenger compartment of the vehicle.

These and other features, aspects and advantages of the present invention will become better understood with reference to the following drawings, description and claims.

### BRIEF DESCRIPTION OF THE DRAWINGS

FIG. 1 is a schematic block diagram of a vehicle with an air purification system in accordance with an embodiment of the present invention;

FIG. 2 is a schematic block diagram of an engine portion of the vehicle of FIG. 1 in accordance with an embodiment of the invention;

FIG. 3 is a chart showing a relationship of temperatures of heated ambient air and operating conditions of the vehicle of FIG. 1 in accordance with an embodiment of the present invention;

FIG. 4 is schematic block diagram of a vehicle with an air purification system in accordance with another embodiment of the present invention; and

FIG. 5 is a flow chart of a method for purifying air for an enclosed cabin of a vehicle in accordance with an embodiment of the present invention.

### DETAILED DESCRIPTION OF THE INVENTION

The following detailed description is of the best currently contemplated modes of carrying out exemplary embodiments of the invention.

The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide for ambient-air decontamination by using heat from an engine of the vehicle to raise the temperature of incoming ambient air so that catalytic decontamination may be performed. More particularly, embodiments of the present invention may extract heat for multiple locations of an engine system so that ambient air may be heated to a temperature that is within an operating range of an on-board catalytic oxidation or decontamination (CATOX) unit. Alternatively, embodiments of the present invention may extract heated ambient air from the engine and combine the engine-heated air with ambient air heated in a dedicated heater to provide an ambient-air temperature within the desired temperature range. Embodiments of the present invention may be particularly useful in vehicles which may be operated with varying engine loading conditions in which heated ambient air from any one location on the engine system may vary outside of an operating temperature range of the CATOX unit.

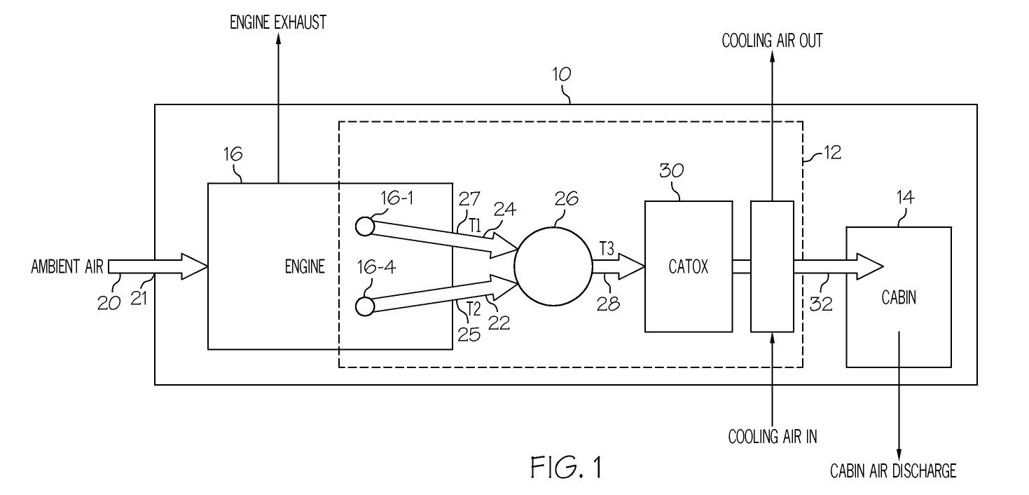

Referring now to FIG. 1, a block diagram schematically illustrates a vehicle 10 with an ambient-air decontamination system 12 and an enclosed cabin 14 for occupants. The vehicle 10 may also comprise an engine 16. In an exemplary embodiment of the invention, the vehicle 10 may be operated in an environment in which ambient air 20 may be contaminated. In operation of the vehicle 10, the ambient air 20 may be drawn into an inlet 21 and then into the engine 16. Some of the ambient air 20 may be used to support combustion within the engine 16. A portion of the ambient air 20 may be extracted from the engine 16 as bleed air and then used to supply the cabin 14 with breathable air.

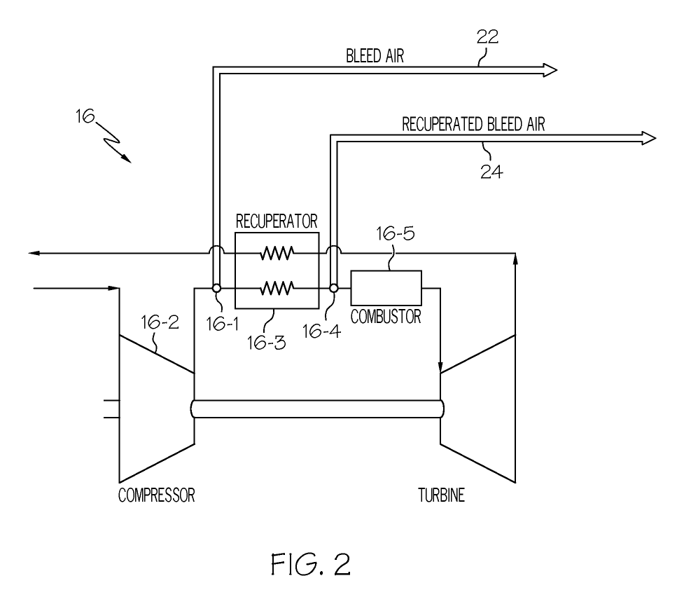

In the exemplary embodiment of FIG. 1, the vehicle 10 may be a tank and its engine 16 may be a turbomachine equipped with a recuperator as shown schematically in FIG. 2.

Referring now to FIG. 2, it may be seen that some of the ambient air 20 may be extracted from the engine 16 at an extraction point or bleed air port 16-1 located between a compressor 16-2 and a recuperator 16-3. The ambient air extracted at port 16-1 may be referred to as a first portion of heated ambient air or bleed air 22. It may also be seen that some of the ambient air 20 may be extracted from the engine 16 at an extraction point or bleed air port 16-4 located between the recuperator 16-2 and a combustor 16-5. The ambient air extracted at the port 16-4 may be referred to as a second portion of heated ambient air or recuperated bleed air 24.

Referring back to FIG. 1, it may be seen that the bleed air 22 may be directed to a mixing valve 26 through a first heated-ambient-air channels 25. and the recuperated bleed air 24 may be directed to the mixing valve 26 through a second heated-ambient-air channels 27 The mixing valve 26 may combine varying portions of the bleed air 22 and the recuperated bleed air 24 to deliver an air mixture 28 to a catalytic decontamination (CATOX) unit 30. The bleed air 22 may be provided at a variable temperature T1 and the recuperated bleed air may be provided at a variable temperature T2. The air mixture 28 may be provided to the CATOX unit 30 at a temperature that is within a temperature range T3.

In a typical one of the vehicles 10, the CATOX unit 30 may be constructed to operate at various temperatures which range from about 400° F. to about 1100° F. For example a CATOX unit such as that disclosed in U.S. Pat. No. 7,132,086 (incorporated by reference herein) may have an operating temperature of between about 500° F. and about 830° F. However, heated air emerging from any one point of the engine 16 may not always be within the temperature range T3. Varying operating conditions of the vehicle 10 may result in variations of the temperatures T1 and T2.

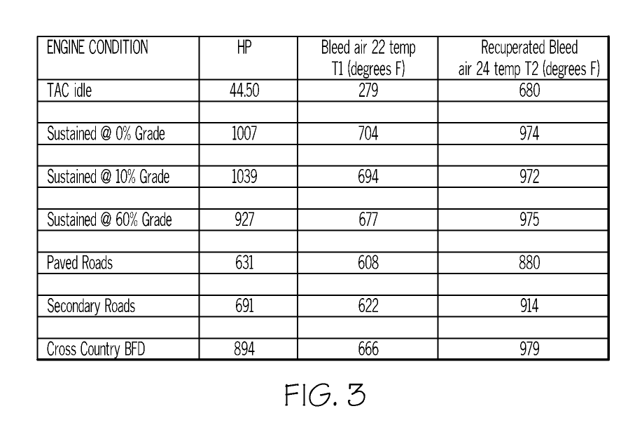

Referring now to FIG. 3, a table shows exemplary relationships between operating conditions of the vehicle 10 and the temperatures T1 and T2 under conditions in which ambient air is a temperature of about 60° F. When the vehicle 10 is at tactical idle, the vehicle may be producing power at a low rate, e.g. 44.5 Horsepower (HP). In this idling condition the bleed air 22 may emerge from the engine 16 at a temperature T1 of about 279° F., which temperature is below a desired temperature range T3 (e.g., 500° F. to 830° F.). Thus, it would appear that the bleed air 22 may not be useful as a source of heated air for the CATOX unit 30 under tactical idling conditions. However, it may be noted that the recuperated bleed air 24 may emerge from the engine 16 at a temperature T2 of about 680° F. during tactical idling. Thus the recuperated bleed air 24 could be used as a source of heated air for the CATOX unit 30 during tactical idling.

But, it may be further noted that under any conditions other than tactical idling, the temperature T2 of the recuperated bleed air 24 may be higher than the desired temperature range T3. For example, during cross-country operation, secondary road operation and sustained grade operation, T2 may exceed 900° F. However, under these circumstances, the bleed air temperature T1 may be high enough to be within the desired T3 range.

Referring back to FIG. 1, it may be seen that the mixing valve 26 may be employed to mix varying amounts of the bleed air 22 and the recuperated bleed air 24 in order to provide the air mixture 28 at a temperature that is within the temperature range T3. Furthermore, it may be seen that mixing valve 26 may maintain a flow of the air mixture 28 within the T3 range, irrespective of the operational status of the vehicle 10. For example, the air mixture 28 may comprise a first volume of the bleed air 22 which may exceed a second volume of the recuperated bleed air 24 when the vehicle 10 is operating in engine-loaded conditions such as cross-country operation, secondary road operation or sustained grade operation. With the vehicle idling, the air mixture 28 may comprise a first volume of the bleed air 22 which may be smaller than a second volume of the recuperated bleed air 24. Consequently, a vehicle 10 such as that shown in the embodiment of FIG. 1 may not require a dedicated heater (not shown) for heating the ambient air 20 to a desired temperature for decontamination in the CATOX unit 30.

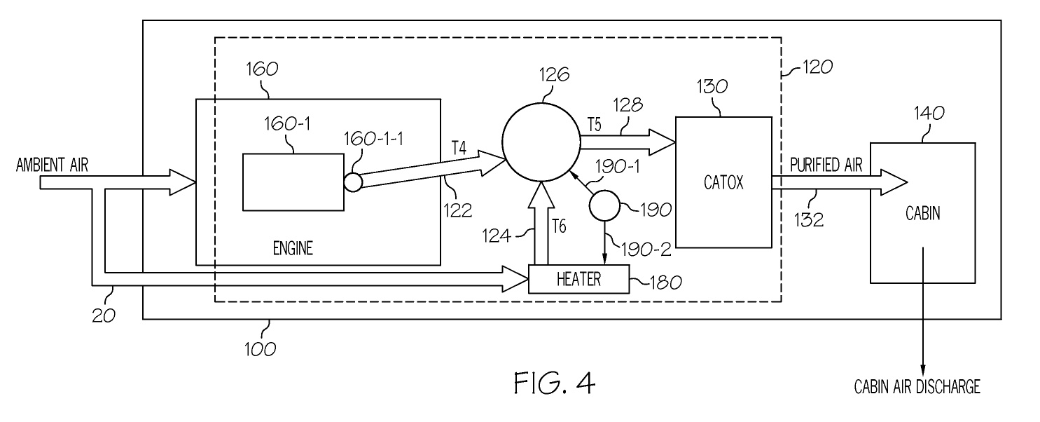

Referring now to FIG. 4, another exemplary embodiment may be schematically illustrated in block diagram format. In FIG. 4, a vehicle 100 (e.g. a military patrol vehicle) may comprise an ambient-air decontamination system 120 and an enclosed cabin 140 for occupants. The vehicle 100 may also comprise an engine 160. The engine 160 may be a reciprocating piston engine with a turbocharger 160-1. The vehicle 100 may be operated in an environment in which ambient air 20 may be contaminated. In operation of the vehicle 100, the ambient air 20 may be drawn into the turbocharger 16. Some of the ambient air 20 entering the turbocharger may be used to support combustion within the engine 16. Some of the ambient air 20 entering the turbocharger 160-1 may be extracted from the turbocharger 160-1 as bleed air through a bleed air outlet 160-1-1 and then used to supply the cabin 140 with breathable air after being decontaminated. In that regard the turbocharger 160-1 may be considered a first heated-ambient-air source for heated ambient air 122.

Ambient air 20 may also be drawn into a second heated-ambient-air source 180 which may be a fuel-fired heater or a heat exchanger such as a recuperator heated with turbocharger exhaust, referred to hereinafter as a heater 180. The heater 180 may produce heated ambient air 124. A mixing valve 126 may combine the heated ambient air 122 and the heated ambient air 124 to produce a heated ambient air mixture 128. A catalytic decontamination unit 130 may receive the air mixture 128 from the mixing valve 126 and decontaminate the air mixture 128.

A temperature controller 190 may be provided to produce proportioning signals 190-1 to the mixing valve 126 and heating command signals to the heater 180. The signals 190-1 and 190-2 may vary in correspondence with operating conditions of the vehicle 100. For example, when the vehicle 100 is in an idling condition a temperature T4 of the heated ambient air 122 may be lower than an operating temperature range T5 of the catalytic decontamination unit 130. In that case the temperature controller 190 may produce a command signal 190-2 to the heater so that the heater 180 may heat the heated ambient air 124 to a temperature T6 which may be as high or higher than the operating temperature range T5 of the catalytic decontamination unit 130. The temperature controller may also produce a proportioning signal 190-1 to the mixing valve 126 so that the mixing valve 126 utilizes a proportionally higher volume from the heated ambient air 124 to produce the air mixture 128. Conversely, when the vehicle may be operated under engine-loaded conditions and when the temperature T4 may exceed equal or exceed the temperature T5, the temperature controller 190 may produce a command signal to turn off the heater 180.

Consequently, a vehicle 100 such as that shown in the embodiment of FIG. 4 may require operation of dedicated heater such as the heater 180 only during limited periods of vehicle operation (e.g. during idling).

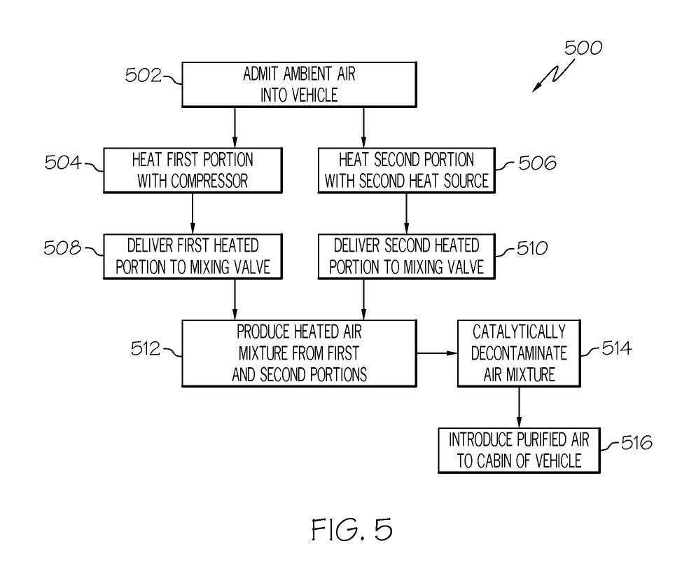

In one embodiment of the present invention, a method is provided for providing decontaminated air to an enclosed passenger cabin of a vehicle operated in contaminated ambient air. In that regard the method may be understood by referring to FIG. 5. In FIG. 5, a flow chart may portray various aspects of a method 500. In a step 502, ambient air may be admitted into the vehicle (e.g., ambient air 20 may be admitted into the vehicle 10 through the inlet 21). In a step 504 a first portion of the admitted ambient air may be heated with a first ambient-air heater comprising a compressor of an engine of the vehicle to produce a first portion of heated ambient air (e.g., the heated ambient air 22 may be produced with heat produced by the compressor 16-2 of the engine 16). In a step 506, the first portion of heated ambient air may be delivered to a mixing valve (e.g., the heated ambient air 22 may be delivered to the mixing valve 26). In a step 508, a second portion of the ambient-air may be heated with a second ambient-air heater to produce a second portion of heated ambient air (e.g., the heated ambient air 24 may be produced with heat produced by the compressor 16-1 and the recuperator 16-3 of the engine 16; or alternatively the heated ambient air 124 may be produced with heat produced by the heater 180 of the vehicle 100). In a step 510, the first and second portions of heated ambient air may be mixed in the mixing valve to produce controlled-temperature heated ambient air at a temperature within an operating range of a catalytic decontamination unit of the vehicle (e.g., heated ambient air 22 and 24 may be mixed in the valve 26 to produce the air mixture 28 at a temperature T3). In a step 512, the controlled-temperature heated ambient air may be catalytically decontaminated to produce purified air (e.g., the catalytic decontamination unit 30 may decontaminate the air mixture 26 to produce purified air 32). In a step 514, the purified air may be introduced into an enclosed passenger compartment of the vehicle (e.g., purified air 32 may be introduced into the cabin 14 of the vehicle 10).

It should be understood, of course, that the foregoing relates to exemplary embodiments of the invention and that modifications may be made without departing from the spirit and scope of the invention as set forth in the following claims.

We claim:

1. An air purification system for a vehicle comprising;
a first heated-ambient-air source comprising an engine with:
an ambient air compressor; and
at least one heated-ambient-air outlet;
a second heated-ambient-air source;
a mixing valve;
a first heated-ambient-air channel connected between the at least one heated-ambient-air outlet of the engine and the mixing valve;
a second heated-ambient-air channel connected between the second heated-ambient-air source and the mixing valve; and
a catalytic decontamination unit positioned between the mixing valve and an enclosed passenger cabin of the vehicle for removing contaminants from ambient air and producing decontaminated air to the enclosed passenger cabin.

2. The air purification system of claim 1 wherein the second heated-ambient-air source comprises a second heated-ambient-air outlet of the engine.

3. The air purification system of claim 1 wherein the catalytic decontamination unit has a temperature operating range between 500° F. and 830° F.

4. The air purification system of claim 1:
wherein the engine comprises a turbine engine; and
wherein first and the second heated-ambient-air sources comprise bleed-air outlets of the engine.

5. The air purification system of claim 4:
wherein the engine comprises a recuperator; and
wherein the second heated-ambient air source comprises a recuperated-bleed-air outlet.

6. The air purification system of claim 5:
wherein the first heated-ambient-air source produces heated ambient air at a first temperature lower than a desired catalytic reaction temperature when the vehicle is idling;
wherein the second heated-ambient-air source produces heated ambient air at a second temperature higher than a desired catalytic reaction temperature when the vehicle operating in a non-idling mode; and
wherein the catalytic decontamination unit is proportionally provided with ambient air from the first and second heated-ambient air sources with proportions that vary as a function of engine loading conditions of the vehicle.

7. The air purification system of claim 1 wherein:
the engine is a reciprocating piston engine;
the first heated-ambient-air source comprises a bleed air outlet of an engine turbocharger; and
the second heated-ambient-air source is a heater.

8. A vehicle comprising:
an enclosed passenger compartment isolated from ambient air;
at least one inlet for ambient air;
at least first and second sources of heat for heating the ambient air;
at least a first one of the at least two sources of heat comprising an engine with:
an ambient air compressor; and
at least a first heated-ambient-air outlet;
a temperature-controlled mixing valve;
a first heated-ambient-air channel connected between the at least one heated-ambient-air outlet of the engine and the mixing valve;
a second heated-ambient-air channel connected between a second heated-ambient-air source and the mixing valve;
a catalytic decontamination unit positioned between the mixing valve and an enclosed passenger cabin of the vehicle for removing contaminants from ambient air and producing decontaminated air to the enclosed passenger cabin;
wherein the first source of heat produces heated ambient air suitable for the catalytic decontamination unit only when the vehicle operates under engine-loaded conditions; and
wherein the second source of heat produces heated ambient air suitable for the catalytic decontamination unit when the vehicle is in an idling condition.

9. The vehicle of claim 8 wherein the second source of heat for heating the ambient air comprises a second heated-ambient-air outlet of the engine.

10. The vehicle of claim 1:
wherein the engine comprises a turbine engine; and
wherein first and the second heated-ambient-air sources comprise bleed-air outlets of the engine.

11. The vehicle of claim 10:
wherein the engine comprises a recuperator; and
wherein the second heated-ambient air source comprises a recuperated-bleed-air outlet.

12. The vehicle of claim 10 wherein the catalytic decontamination unit has a temperature operating range between 500° F. and 830° F.

13. The vehicle of claim 12 wherein the wherein the first heated-ambient-air source produces heated ambient air at a first temperature lower than the temperature operating range of the catalytic decontamination unit when the vehicle is idling;
wherein the second heated-ambient-air source produces heated ambient air at a second temperature higher than the temperature operating range of the catalytic decontamination unit when the vehicle operating in a non-idling mode; and
wherein the catalytic decontamination unit is proportionally provided with ambient air from the first and second heated-ambient air sources with proportions that vary as a function of engine loading conditions of the vehicle.

14. The vehicle of claim 1:
the engine is a reciprocating piston engine; and
wherein the first heated-ambient-air source comprises a bleed air outlet of an engine turbocharger.

15. A method for providing decontaminated air to an enclosed passenger cabin of a vehicle operated in contaminated ambient air comprising the steps of:
admitting ambient air into the vehicle;
heating a first portion of the admitted ambient air with a first ambient-air heater comprising a compressor of an engine of the vehicle to produce a first portion of heated ambient air:
delivering the first portion of heated ambient air to a mixing valve:
heating the a second portion of the ambient-air with a second ambient-air heater to produce a second portion of heated ambient air;
delivering the second portion of heated ambient air to the mixing valve:
mixing the first and second portions of heated ambient air in the mixing valve to produce controlled-temperature heated ambient air at a temperature within an operating range of a catalytic decontamination unit of the vehicle; and
catalytically decontaminating the controlled-temperature heated ambient air to produce purified air; and
introducing the purified air into the enclosed passenger compartment of the vehicle.

16. The method of claim 15 wherein:
the step of heating the first portion of admitted ambient air comprises compressing the first portion with the compressor of the engine;
the step of delivering the first portion of heated ambient air to the mixing valve comprises extracting bleed air from the compressor of the engine at a first bleed air outlet.

17. The method of claim 16 wherein:
the step of heating the second portion of admitted ambient air comprises:
compressing the second portion with the compressor of the engine to heat the second portion to a first temperature; and
passing the second portion of ambient air through a recuperator of the engine to further heat the second portion to a second temperature higher than the first temperature; and
the step of delivering the second portion of heated ambient air to the mixing valve comprises extracting bleed air from the compressor of the engine at a second bleed air outlet.

18. The method of claim 15 wherein:
the controlled-temperature heated ambient air comprises a volume of the first portion of heated ambient air that exceeds a volume of the second portion of the heated ambient air when the vehicle is being propelled by the engine; and
the controlled-temperature heated ambient air comprises a volume of the second portion of heated ambient air that exceeds a volume of the first portion of the heated ambient air when the vehicle is operating under idling conditions.

19. The method of claim 18 wherein the controlled-temperature heated ambient air comprises varying volumes of the first and second portions of hated ambient which volumes vary as a function of engine-loading conditions of the vehicle.

20. The method of claim 15 wherein the step of heating the first portion of the admitted ambient air is performed with a turbocharger of a reciprocating piston engine of the vehicle.
